(19) United States
(12) Patent Application Publication
(10) Pub. No.: US 2017/0319909 A1
(43) Pub. Date: Nov. 9, 2017

(54) LOCATION-AWARE AUTONOMOUS SELF-PROPELLED BALLS

(71) Applicant: Meyer Freeman, Portland, OR (US)

(72) Inventor: Meyer Freeman, Portland, OR (US)

(21) Appl. No.: 15/588,365

(22) Filed: May 5, 2017

Related U.S. Application Data
(60) Provisional application No. 62/332,265, filed on May 5, 2016.

(51) Int. Cl. A63B 43/00; A63B 24/00

(52) U.S. Cl. CPC A63B 43/004; A63B 24/0021; A63B 2220/12; A63B 2024/0053

(57) ABSTRACT

Embodiments provide apparatuses, systems, and methods associated with a location-aware autonomous self-propelled sports ball. The sports ball may detect its location relative to one or more locator tags and control its self-propelled movement based on the detected location. The locator tags may be worn by respective users of the sports ball and/or placed on the ground. The sports ball may operate in different modes that control movement of the sports ball relative to the one or more locator tags, such as tag, chase, auto-return, side-to-side, and race. Other embodiments may be described and/or claimed.

### CROSS REFERENCE TO RELATED APPLICATION

The present application claims priority to U.S. Provisional Patent Application No. 62/332,265, titled “LOCATION AWARE AUTONOMOUS SELF-PROPELLED BALLS,” filed May 5, 2016, the disclosure of which is hereby incorporated by reference in its entirety.

### TECHNICAL FIELD

Embodiments herein relate to the field of toys and sports equipment, and, more specifically, to balls designed for play or sports that are self-propelled and location-aware relative to the user.

### BACKGROUND

Balls of various sorts have been used for recreation and sports throughout history. Most major sports enjoyed today involve the use of balls: basketball, baseball, volleyball, soccer, and football are all examples of modern sports that use some sort of ball. Likewise, balls are frequently used for recreational purposes or with a pet, such as games of catch or fetch. Balls used in sports and/or for recreation are commonly “dumb”; that is, they are non-electronic, filled with air or another suitable substance and are ideally designed to be durable with respect to the sport or activity for which they are employed. Play with such balls typically involves throwing, catching, and kicking.

With the advent of microelectronics, new toys capable of autonomous and/or guided movement have become possible. Such toys can be manufactured in a variety of shapes, and accomplish a variety of activities, including allowing recreation on an interactive level. In some cases, the toys can be programmed to follow various patterns that help improve engagement with the toy.

Known balls and autonomous toys are not entirely satisfactory for the range of applications in which they are employed. For example, as mentioned above, existing balls do not move autonomously so as to encourage ongoing engagement, although they can possess superior durability to withstand rough play. Conversely, conventional autonomous toys typically lack the durability of balls for heavy play, despite being programmable to encourage and enhance engaging play.

Thus, there exists a need for balls that improve upon and advance the design of known balls used for recreation and sports. Examples of new and useful balls relevant to the needs existing in the field are discussed below.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 is a block diagram of the components of a first example of a location-aware autonomous self-propelled ball.

FIG. 2 is a diagram view of the location-aware autonomous self-propelled ball shown in FIG. 1 depicting its interaction with a user.

FIG. 3 is a cross-sectional view of a location-aware autonomous self-propelled ball shown in FIG. 1 depicting a possible arrangement of the internal components.

FIGS. 4A-4C are perspective views of possible additional embodiments of a location-aware autonomous self-propelled ball.

FIG. 5 is a block diagram of the components of an example locator tag in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense.

Various operations may be described as multiple discrete operations in turn, in a manner that may be helpful in understanding embodiments; however, the order of description should not be construed to imply that these operations are order-dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

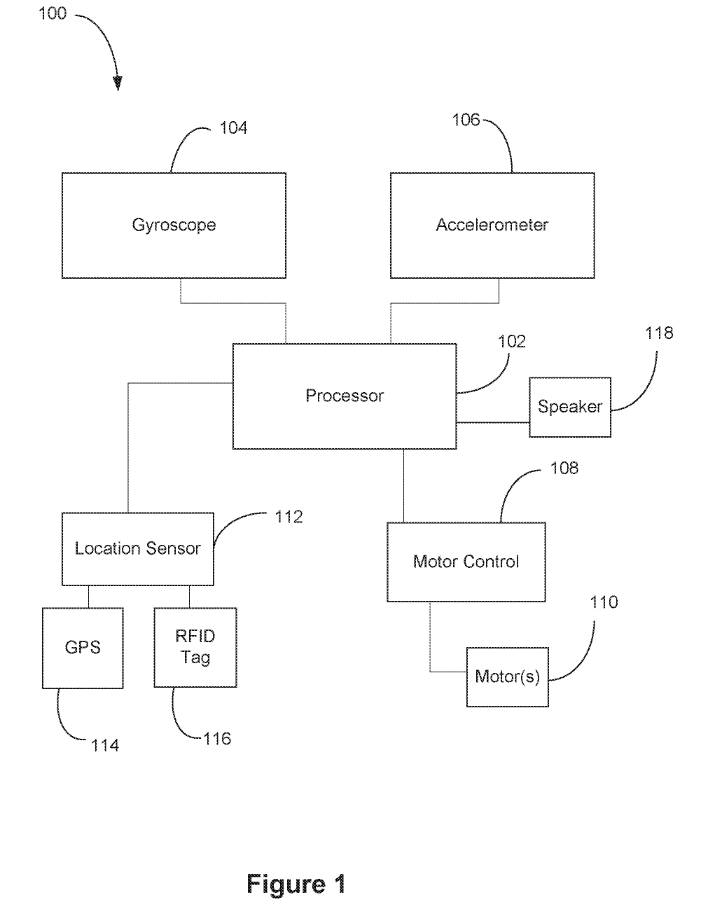

Embodiments herein provide a location-aware autonomous self-propelled ball. With reference to FIGS. 1-3, a first non-limiting example of a location-aware autonomous self-propelled ball, ball 200 will now be described. Ball 200 functions to provide an autonomous self-moving toy in a sports-ball form factor. Additionally or alternatively, ball 200 may be used in conjunction with one or more locator tags that indicate their position to the ball 200 and/or may be used to control the ball 200. The locator tags may be worn by one or more users or placed in the area where the ball 200 may be used. The one or more locator tags may include, for example, one or more dedicated locater tags that are specifically designed to be used with the ball 200 (e.g., a bracelet that may be worn by the user or a cone or other object that may be placed on the ground), or a wireless communication device (e.g., smartphone, smart watch, etc.) that may include an associated application that interacts with and/or controls the ball 200.

Ball 200 addresses many of the shortcomings existing with conventional balls and autonomous toys. For example, ball 200 may be supplied in a housing comparable in construction and materials to existing balls. Such a housing may provide durability comparable to existing sports balls, allowing ball 200 to be played with roughly, such as being thrown or kicked, or used with a pet such as a dog. Additionally, the autonomous features of the ball 200 may provide an interactive and engaging play experience. While many of the examples below are described with reference to specific ways of a user moving the ball 200 (e.g., kicking, throwing, rolling, etc.), it will be apparent that the various operational modes of ball 200 may also be used with other suitable ways of moving the ball 200.

FIG. 1 is a schematic block diagram 100 showing various components of the ball 200. The components of ball 200 may be coupled to one another as shown or in another suitable arrangement. Additionally, although the components are shown as discrete elements, in some cases two or more components may be performed by the same device. Alternatively, or additionally, in some embodiments the functions of a component shown in block diagram 100 may be performed by separate devices.

As shown in FIG. 1, the ball 200 includes a processor 102, which is in data communication with a variety of supporting peripherals. Such peripherals may include positional sensors such as a gyroscope 104 and/or accelerometer 106, motor controller 108, and/or location sensor 112. In other examples, the ball 200 may include a Global Positioning System (GPS) receiver 114, and/or a radio frequency identification (RFID) tag reader 116. In still other examples, ball 200 may include a transceiver to interact with one or more locator tags or other supporting devices (e.g., a smartphone app or other external control program).

As can be seen in FIG. 1, processor 102 provides the central control functionality for ball 200. Processor 102 may be implemented using any currently existing or later developed technology, such as a general processor, embedded controller, or custom-developed integrated circuit. Examples of possible implementations include the Atmel ATMega family of general purpose microcontrollers, ARM-based processors, Intel Atom low power processors, or similar general purpose processors (e.g., processors available in a System on a Chip (SoC) architecture for use in small computers). General purpose processors that are geared to laptops and desktops, such as the Intel Core line of processors, could be used in some implementations that offer sufficient space to include the necessary supporting chipsets required by such processors. Other implementations may utilize custom developed application-specific integrated circuits (ASICs). Still other implementations may utilize a set of chips to achieve the necessary functionality. Processor 102 may include various support components, such as a system bus and data storage. Data storage may include both volatile and non-volatile memory, and may be programmed with instructions that direct and control the behavior of ball 200. A system bus may be used to communicate between processor 102, data storage, and any attached peripherals, such as location and motion sensing devices. Processor 102 may also be selected with consideration given to power consumption, to achieve a desired runtime. Most of the aforementioned SoC architectures are designed to have low power consumption, as they are intended to be used in battery powered applications.

Attached to processor 102 via a data bus are one or more internal sensors that measure one or more parameters (e.g., orientation, acceleration, altitude, etc.) associated with the ball 200 to facilitate movement and/or control of the ball 200. FIG. 1 shows two possible internal sensors, gyroscope 104 and accelerometer 106. These two sensors may be used in a closed feedback control loop (e.g., a proportional-integral-derivative (PID) control loop) to provide stabilization and control of motion. For example, gyroscope 104 is used to help keep internal drive mechanisms of the ball 200 in an upright orientation. Additionally, accelerometer 106 may detect when ball 200 is upright, and/or can be used to detect when ball 200 has been moved by the user (e.g., thrown, kicked, rolled, etc.), e.g., to enable the drive mechanisms to be selectively disabled so that the drive mechanisms are not unnecessarily engaged, and/or to feed the information to processor 102 to trigger various phases of play programs, which will be described further below. Similarly, accelerometer 106 can detect when ball 200 is again on the ground, and thus in a position to begin autonomous movement. Gyroscope 104 and accelerometer 106 are typically implemented using microelectromechanical systems (MEMS) technology, although any technology for constructing the sensors that provides a suitably small, accurate, and low power design appropriate to ball 200 may be used. Gyroscope 104 and accelerometer 106 can also be integrated into a single sensor package, such as the Invensense MPU-6050 six-axis motion detector. A person skilled in the relevant art will appreciate that gyroscope 104 and accelerometer 106 are only two possible sensor packages. Depending upon the intended use and behavior of ball 200, fewer, more or different sensor packages may be employed, such as a magnetic compass detector and/or an atmospheric barometer.

Processor 102 is also in data communication with motor controller 108. Motor controller 108 in turn powers and controls the speed and motion of one or more motors 110. Motor controller 108 is responsible for the motion of ball 200, as it translates directional instructions from processor 102 into signals that drive motors 110 to make ball 200 follow the course determined by processor 102. Motor controller 108 will typically be implemented using power control circuitry, such as metal-oxide-semiconductor field-effect transistors (MOSFETs) for switching power to motors 110 for speed control, although motor controller 108 can be implemented using any suitable power control technology now known or later developed. The specific implementation of motor controller 108 will depend upon the specific type of motor 110 that is utilized. For example, where motor 110 is implemented using a brushless design, motor controller 108 will need to provide electronic commutation to drive motor 110. Conversely, where motor 110 is implemented using a traditional brushed design, such as in a coreless design, motor controller 108 may implement power-train control module (PCM) control of a direct current (DC) drive current to control the speed of motor 110. Depending upon the level of control outputs from processor 102, motor controller 108 may itself include a dedicated processor and memory where processor 102 outputs high-level commands. Conversely, motor controller 108 can be less complex where the task of generating a signal for speed control modulation is handled directly by processor 102.

As mentioned above, motor 110 may be implemented using a variety of technologies, such as electronically commutated brushless, or traditional brushed using a cored or coreless design. The decision of which technology to use may be made with consideration to torque and/or power needs, as well as weight and/or power consumption. Motor 110 interfaces to drive ball 200, and will be discussed in greater detail below. Motor 110 may further be physically integrated with motor controller 108.

In various embodiments, location sensor 112 is in communication with processor 102 to provide processor 102 the location of ball 200, e.g., so that processor 102 can direct motor controller 108 to guide ball 102 in an autonomous fashion relative to a user or other supporting device. Location sensor 112 in turn is in communication with one or more location sensing devices, such as GPS receiver 114 and/or RFID tag receiver 116. GPS receiver 114 and RFID tag receiver 116 work in the conventional fashion that is well known in the relevant art. GPS receiver 114 may rely upon GPS, Global Navigation Satellite System (GLONASS), Galileo, and/or any other global navigation satellite system now known or later developed. RFID tag receiver 116 may be tailored to the particular RFID or other radio locator tag technology employed. In some embodiments, the RFID tag receiver 116 may be designed to home in on or be paired to a single tag. The ball 200 may include multiple RFID tag receivers 116 to home in on or be paired to respective locator tags. Other possible location sensing technologies may be employed, such as a radio-, laser-, or visual-based system, depending upon the needs and intended usage of ball 200. Location sensor 112 may further be integrated with the location sensing devices, or may be integral with each location sensing device so as to be tailored to the specific output of its associated location sensing device. The output of location sensor 112 will depend upon the implementation of processor 102.

In some embodiments, the ball 200 may further include speaker 118 coupled to the processor 102. The processor 102 may cause the speaker 118 to output various sounds that are selected based on a mode of operation of the ball 200, the location of the ball 200 (e.g., relative to one or more locator tags 206), and/or data from one or more of the internal sensors (e.g., the gyroscope 104 and/or accelerometer 106). For example, the ball 200 may output different sounds depending on which mode of operation is activated (e.g., an engine sound during the race mode, a voice saying “I'm going to get you” during the tag mode, and/or a voice saying “you can't catch me” during the chase mode). It will be appreciated that a wide variety of different sounds may be used during the various modes of the ball 200. Additionally, or alternatively, the ball 200 may detect when it crosses a goal line (e.g., based on one or more location tags 206 that are placed on the goal line), and the speaker 118 may output a sound based on the detection. For example, the speaker 118 may output a cheering sound, music, and/or another suitable sound. Additionally, or alternatively, the speaker 118 may output a sound responsive to the ball 200 detecting that it has been contacted and/or moved by the user (e.g., based on information from one or more of the internal sensors). In some embodiments, the sound that is selected for output may be further based on the mode of operation of the ball 200. For example, the ball 200 may output a first sound when it is moved by the user (e.g., kicked, thrown, rolled, etc.) during the return mode, a second sound when it contacts the user during the tag mode, and/or a third sound when it contacts the user during the chase mode.

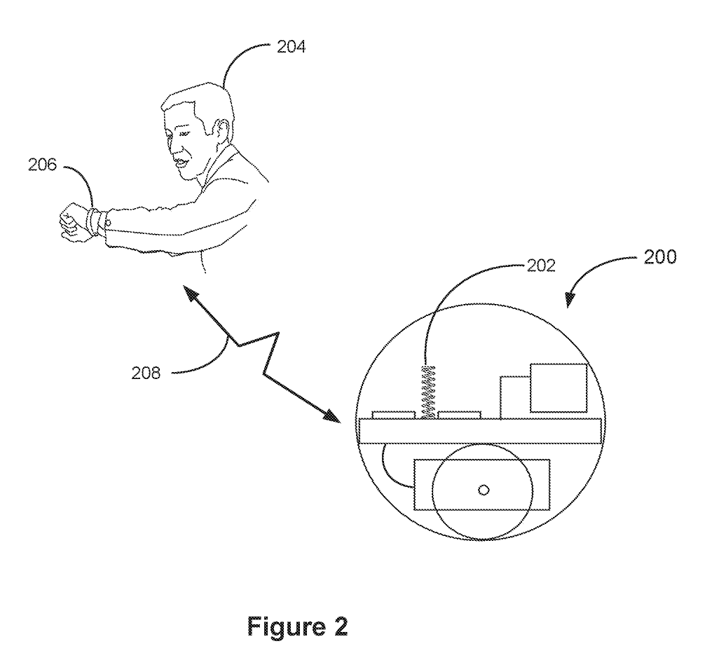

In the example shown in FIG. 2, ball 200 is depicted in an example use scenario. Ball 200 possesses a receiving antenna 202, which may be coupled to location sensor 112 and detects a location signal, either from a GPS system as described above, other type of locating system, or a locator tag 206 worn by a user 204. Where a locator tag 206 is used, there may a wireless communication link 208 that facilitates a routine polling of locator tag 206 to allow ball 200 to periodically update its location relative to user 204, and/or to enable the locator tag 206 to control operation of the ball 200. The wireless communication link 208 may use any suitable communication protocol, such as RFID, Bluetooth, a cellular connection (e.g., a Third-Generation Partnership (3GPP) cellular connection, such as a Long Term Evolution (LTE) or LTE Advanced connection), a wireless local area network (e.g., WiFi) and/or another suitable communication protocol.

In some embodiments, locator tag 206 may be an RFID tag implemented using RFID technology. An example of such technology that could be usefully deployed with the disclosed invention is Ultra Wideband (UWB) RFID technology, which allows determining the location of an RFID tag with a high degree of precision, and is operable over a range sufficient to allow routine play with ball 200. Locator tag 206 can, however, be implemented using other technologies, so long as the technology allows for ball 200 to locate the position of locator tag 206 with relative accuracy.

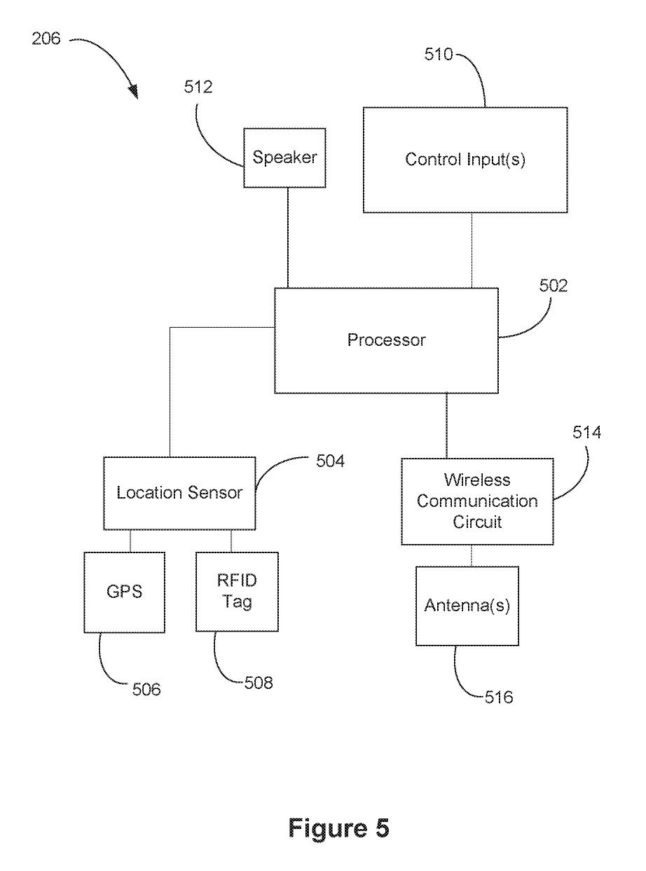

A schematic block diagram of an example locator tag 206 is shown in FIG. 5. Locator tag 206 may be implemented in a dedicated device to be used with the ball 200, such as a bracelet, a belt, a clip-on device, or other wearable device, or a cone or other device suitable for being placed on the ground. In other embodiments, the locator tag 206 may be implemented in a smartphone, smartwatch, or other consumer electronic device, e.g., with an associated application. Locator tag 206 may include a processor 502, and a location sensor 504. Location sensor 504 may use any suitable mechanism to enable the ball 200 to determine the location of the ball 200 relative to the locator tag 206. For example, the location sensor 504 may include or be coupled with a GPS sensor 506 and/or RFID tag 508. In some embodiments, locator tag 206 may be equipped with one or more control inputs 510, such as buttons, a touch screen, a microphone (e.g., to receive voice commands), and/or other suitable control inputs to receive commands from the user and cause the locator tag 206 to send signals to ball 200 that trigger various behaviors, e.g. return to home, switch play modes, power on/off, etc.

In some embodiments, locator tag 206 may further include a speaker 512 to output audio. The audio output by the locator tag 206 may be similar to the audio described above with respect to the speaker 118 of ball 200. The locator tag 206 may output audio in addition to or instead of the ball 200.

As discussed above, the processor 502 may be in wireless communication with the ball 200 via wireless communication link 208. For example, the locator tag 206 may further include a wireless communication circuit 514 and/or one or more antennas 516 coupled to the processor 502 to enable communication via the wireless communication link 208. The wireless communication circuit 514 may be included in the processor 502 or provided on a separate chip. The wireless communication link 208 may be used to facilitate the ball 200 to determine its location relative to the locator tag 206, to send control commands from the locator tag 206 to the ball 200, and/or to send information from the ball 200 to the locator tag 206 (e.g., to initiate sounds on the locator tag 206 or provide operational data such as the speed at which the ball was moved by the user).

Wireless communication link 208, with a typical RFID implementation, involves a query from ball 200 and a response from locator tag 206. The contents, bandwidth, and utilized radio bands of the query and response will depend upon the particular RFID technology deployed in locator tag 206. The parameters of communication link 208 may also inform the design of receiving antenna 202. Furthermore, receiving antenna 202 may be implemented as a plurality of antennas, so as to provide a diversity style receiver to improve the clear reception of weaker RFID signals.

In operation in the implementation in which user 204 wears a locator tag 206, ball 200 operates by routinely broadcasting a query for the location of locator tag 206. Locator tag 206 responds with a signal that the location sensor 112 in ball 200 can use to determine the location in space of ball 200 relative to locator tag 206, and by correspondence, user 204. Repeated queries allow ball 200 to update its location as it moves relative to user 204. A potential method of use included user 204 throwing, kicking, or otherwise moving ball 200, and upon landing ball 200 determines its location relative to user 204, and initiates travel back to user 204. By using a locator tag 206 attached to user 204, as user 204 moves about a field of play, ball 200 can adjust its travel path to consistently return to user 204.

Ball 200 can be paired to a specific locator tag 206, where the equipped RFID tag transmits a unique identifier code. This will allow multiple balls 200 to be used in proximity, with each respective ball 200 being tied to a particular locator tag 206, and hence a particular user 204. Moreover, ball 200 could be programmed to interact with multiple users 204 each wearing distinct locator tags 206, thus creating a play scenario where ball 200 chases between various people in a group, possibly pursuing the locator tag 206 in closest proximity to ball 200, such as simulating a game of tag.

As mentioned above, GPS technology can allow ball 200 to locate itself without the need for user 204 to wear a homing device or location tag. In such an implementation, user 204 preferably remains relatively stationary, and ball 200 determines an initial starting location upon power-up. This initial starting location is memorized, and ball 200 will return to the location as dictated by the programming associated with processor 102. If user 204 leaves the memorized location, ball 200 may not return to user. Other possible implementations could have ball 200 sensing when it is being moved by the user (for example, by use of gyroscope 104 and accelerometer 106), and triggering processor 102 to memorize a new point of origin just prior to user 204 throwing or kicking ball 200. In such an implementation user 204 would be expected to pick up ball 200 as it returns to its memorized starting point. Upon being picked up, ball 200 would then initiate the process of memorizing a new initial starting location. Following throwing or kicking, ball 200 would use GPS receiver 114 to determine its current position relative to the memorized initial starting location, and navigating with respect to the initial starting location.

Still further methods of operation for ball 200 may use GPS, but integrate it with one or more additional location sensors, such as a visual system for locating user 204. The appearance of user 204 may be processed by an on-board vision system, which would then be used to guide ball 200. Other possibilities may rely upon motion detection, where ball 200 locates and pursues or interacts with any proximate object that has detected motion.

It should be appreciated by the reader that the foregoing methods of ball 200 determining its location relative to the user and autonomously responding are merely several possible examples out of many, and a variety of different methods of ball 200 determining its location and the location of user 204 could be implemented without departing from the present disclosure.

The types of interactive behaviors exhibited by ball 200 may be determined by the programming associated with processor 102. Such routines may include games such as tag, fetch, chase, or random behavior. Further still, ball 200 may be equipped with means by which processor 102 can be custom programmed with unique behavior routines as determined by individual users. Possible use modes for which processor 102 may be programmed, some of which have been previously mentioned, include, but are not limited to:

a) Tag—Ball 200 chases after users 204 as if playing a game of tag in which ball 200 is “it,” and moves quickly toward the nearest person. Several users 204 with respective locator tags 206 can play at once. Additionally, or alternatively, multiple balls 200 can be used simultaneously. When users 204 are “tagged,” they can kick ball 200 away from themselves and toward others. In some embodiments, the ball 200 may detect when it contacts a user (e.g., using one or more of the internal sensors, such as the accelerometer), and may stop responsive to the detection to enable the tagged user to kick the ball. In some cases, the ball may stop for a pre-determined amount of time (e.g., 5-20 seconds, such as about 10 seconds) and then continue moving. Such a feature may be useful if the ball stops due to hitting an inanimate object (e.g., a soccer goalpost, basketball hoop support, or other obstacle), or if the tagged user fails to kick the ball. Alternatively, or additionally, the ball 200 may use the location sensor in combination with one or more of the internal sensors to detect when the ball 200 contacts a user, thereby enabling the ball 200 to distinguish between a user and another object. As discussed above, in some embodiments, the speaker 118 of the ball 200 may output a sound while chasing the one or more users during the tag mode and/or responsive to the detection that the ball 200 has contacted the user during the tag mode.

In some embodiments, the speed at which the ball 200 moves during the chase mode may be configurable by the user, e.g., to enable the ball 200 to be used by users of different ages or abilities. The speed may be adjusted using any suitable mechanism, such as a control input on the ball 200 or a control input 508 on the locator tag 206. In some embodiments, the ball 200 may also be programmed to follow the movement of the user 206 without contacting the user.

b) Auto return—In the auto return mode, after the ball 200 is kicked (e.g., toward a goal), the ball 200 may self-propel itself back to the user 204, who can kick it again as ball 200 approaches. The ball 200 may initiate its return to the user 204 when the ball 200 detects that it has stopped or that the speed of the ball 200 has slowed below a threshold after being kicked by the user. Alternatively, user 204 may wear a locator tag 206 that is equipped with a button to trigger ball 200 to return. User 204 may select from multiple possible speeds at which the ball 200 will return to the user 204. Additionally, or alternatively, the user may configure the ball 200 to return from various directions, e.g. to the left side of the user, to the right side of the user, or a randomly selected direction, for an improved physically active experience.

c) Side-to-side—Ball 200 rolls back and forth (e.g., laterally or in another suitable direction) in front of user 204 who can kick it at any time. Following being kicked, an auto-return feature as described above may be activated. This mode may enable the user 204 to practice kicking a moving ball.

d) Race—Ball 200 and user 204 race at one of several possible speeds chosen by user 204. In some embodiments, one or more locator tags 206 may be positioned by user 204 to denote the finish line location. In some embodiments, another locator tag 206 may be positioned to denote the starting location. Alternately, start and finish line locations can be designated by GPS lock. Still further, waypoints may be designated (e.g., by locator tags 206, GPS lock, or another suitable mechanism) to create a winding, rather than linear, race course.

e) Chase—The ball 200 attempts to evade one or more users 204 while the users 204 chase after the ball 200. The ball 200 may move away from the users 204 based on the locations of the users 204. The chase mode may promote teamwork among the users 204 to catch the ball 200. In some embodiments, the ball 200 may detect when it has been contacted by a user 204 (e.g., similar to the detection described above with respect to the tag mode) and stop moving responsive to the detection. In some embodiments, the ball 200 may stop for a pre-determined time period (e.g., 5-20 seconds, such as 10 seconds) after being contacted and then start moving again to start another round of chase. Alternatively, or additionally, the chase mode may be re-initiated by the user, e.g., using a button on the location tag 206 or the ball 200. As discussed above, in some embodiments, the speaker 118 of the ball 200 may output a sound while the ball 200 is moving during the chase mode and/or responsive to a detection that the ball 200 has been contacted by a user during the chase mode.

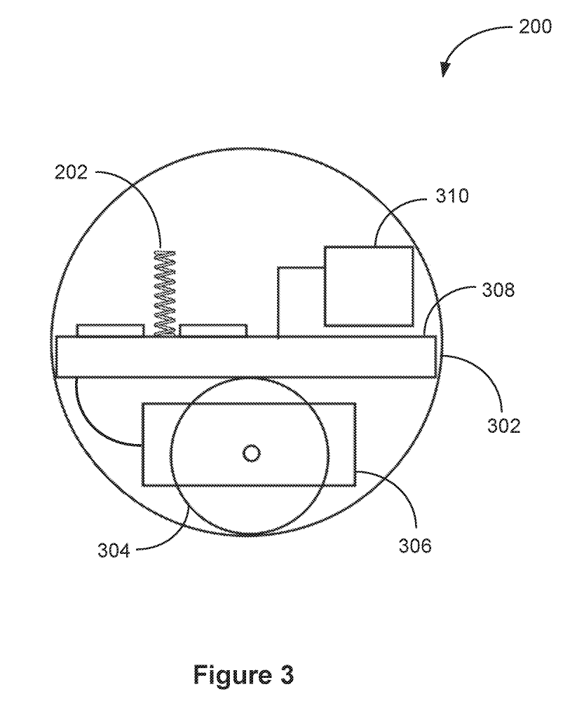

Referring now to FIG. 3, various internal components of ball 200 described above with reference to FIG. 1 are depicted. Ball 200 includes an outer casing 302, one or more drive wheels 304 coupled to and driven by one or more motors 306, and a logic board 308 that is in electrical communication with one or more motors 306. The logic board 308 may include processor 102 and one or more of the various sensors described with reference to FIG. 1. Connected to logic board 308 is power module 310, which supplies power to logic board 308 and motors 306 to allow ball 200 to move autonomously.

Outer casing 302 is preferably constructed of a durable material that can withstand the impacts of being thrown or struck, without transmitting damage to the internal components of ball 200. Such materials may include plastics, polycarbonates, silicones, rubbers, wood, metal, composites, or any other suitably durable materials. The thickness of such materials will depend upon the size of ball 200 and the particular material or materials selected. Outer casing 302 also needs to allow functioning of the internal location sensing devices. For example, where the location sensing devices rely upon radio communications, outer casing 302 must be manufactured from a material that is sufficiently radio transparent to allow the location sensing devices to pick up GPS and/or RFID signals. Outer casing 302 may optionally be able to be disassembled for servicing and/or adjustment of the internal mechanisms of ball 200.

Drive wheels 304, as shown in FIG. 3, mechanically interface with the interior surface of outer casing 302, thereby allowing rotational energy from motors 306 to be transmitted to outer casing 302 and any substrate upon which ball 200 is resting. In some embodiments, the whole of the internal mechanisms of ball 200 only contact the interior of outer casing 302 by way of drive wheels 304, thus allowing outer casing 302 to rotate about the internal mechanisms of ball 200. Gyroscope 104 and accelerometer 106 work to keep the internal mechanisms upright with respect to outer casing 302. Thus, as drive wheels 304 are moved by motors 306, they impart motion to outer casing 302, which rotates about the internal mechanisms and propels ball 200. Multiple drive wheels 304 and motors 306 may be oriented at angles to each other, to enable movement of ball 200 in multiple directions, e.g. forward, back, left and right. Drive wheels 304 can be manufactured from any suitably durable material, such as plastic, rubber, metal, wood, composites, or any other suitable material. Drive wheels 304 may further be equipped with an outer circumference of a friction-enhancing material such as rubber or silicone, so as to maximize traction between drive wheels 304 and outer casing 302, and consequently maximizing the transfer of power from motors 306 to outer casing 302. Alternatively, the interior of outer casing 302 could be coated with a similar material that maximizes the receipt of motion from drive wheels 304.

Motors 306, affixed to drive wheels 304 so as to impart rotational motion to drive wheels 304, were previously described above with reference to FIG. 1, with motors 110. Motors 306 may be in electrical communication with logic board 308, which includes motor controller 108, also described above, thus allowing processor 102 to control the drive of motors 306 and the motion of drive wheels 304.

Power module 310 may include a rechargeable battery pack, such as a lithium ion, lithium polymer, Nickle Metal Hydride, LiFe, or other suitable batter technology that offers light weight with high power density, to maximize life and range of ball 200 upon a single charge. The power module 310 may further include supporting circuitry for monitoring the status of the battery pack as well as to control the charging process. Charging of the battery pack may be accomplished by any suitable means now known or later developed, such as direct plug-in via a port in outer casing 302 that provides access to power module 310, or by way of wireless induction charging, where ball 200 need only be brought in proximity with a corresponding inductive charger that is external to outer casing 302.

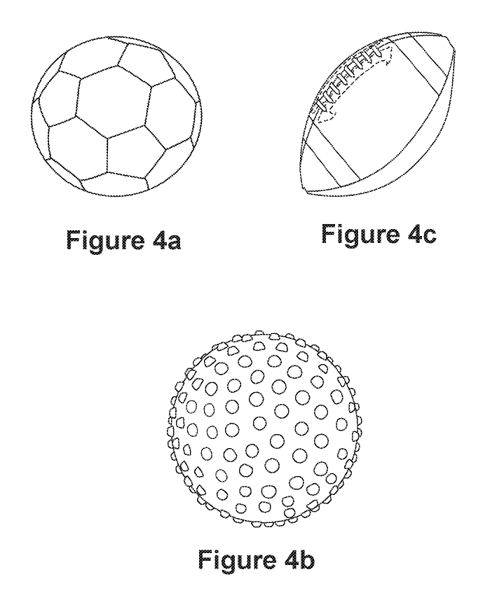

Turning attention to FIGS. 4A-4C, examples of a variations of ball 200 will now be described. The balls disclosed in FIGS. 4A, 4B and 4C may have similar or identical functionality to ball 200, but vary in the design of their outer casings. Thus, for the sake of brevity, each feature of the various balls will not be redundantly explained. Rather, key distinctions between the balls depicted in FIGS. 4A-4C and ball 200 will be described in detail and the reader should reference the discussion above for features substantially similar between the two balls.

As can be seen in FIG. 4A, the ball depicted includes a relatively smoothed or lightly grooved outer surface. Such a ball can be used for general purpose play, or for indoor play areas on relatively flat, smooth surfaces. Where a smooth surface is the intended play surface, the ball's exterior may be made of a high-friction material, such as silicone or rubber, to enhance gripping of a smooth surface. FIG. 4B depicts a ball with a knobbed or knurled surface, suitable for navigation over uneven terrain. Such a surface is suitable for outside play, over grass or dirt surfaces where the various knobs can assist in traction. Additionally, such a knobbed exterior may be more suitable for using ball 200 in connection with pets, where a dog may chase the ball as it moves in a somewhat random pattern. The knobs may present a surface that is more enjoyable for the dog to grip in its mouth. Finally, FIG. 4C depicts a ball in an oblong shape, similar to a football, demonstrating another possible embodiment for ball 200 that does not require a completely spheroid shape. It will be appreciated by a person skilled in the relevant art that the ball depicted in FIG. 4C will not possess the same movements as a spheroid ball. The ball in FIG. 4C demonstrates one possible shape variation. Other possible variations may be implemented that provide different types of autonomous interaction; such variations do not depart from the present disclosure.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

Where the disclosure or claims recite “a” element, “a first” element, or any such equivalent term, the disclosure or claims should be understood to incorporate one or more such elements, neither requiring nor excluding two or more such elements.

What is claimed is:

1. A location-aware self-propelled sports ball, comprising:
a motor assembly to propel the sports ball along the ground;
a location sensor to determine a location of the sports ball relative to an external locator tag;
a processor to control the motor assembly to propel the sports ball based on the determined location of the sports ball relative to the external location tag.

2. The sports ball of claim 1, further comprising a housing that is configured to be kicked by a user, wherein the motor assembly, the location sensor, and the processor are contained within the housing.

3. The sports ball of claim 1, wherein the location sensor is to determine the location of the sports ball relative to a plurality of external locator tags, and wherein the processor is to control the motor assembly to propel the sports ball based on the determined location of the sports ball relative to the plurality of external locator tags.

4. The sports ball of claim 3, wherein, during a tag mode of the sports ball, the processor is to control the motor assembly to propel the sports ball toward a closest external locator tag of the plurality of external locator tags as locations of the plurality of external locator tags change.

5. The sports ball of claim 4, wherein, during the tag mode, the processor is further to:
detect, using one or more internal sensors, when the sports ball has contacted a user associated with one of the plurality of external locator tags, and;
control the motor assembly to stop propulsion of the sports ball responsive to the detection that the sports ball has contacted the user.

6. The sports ball of claim 5, wherein the processor is to control the motor assembly to stop propulsion of the sports ball for a pre-determined time period after the detection that the sports ball has contacted the user.

7. The sports ball of claim 5, further comprising a speaker coupled to the processor, wherein the speaker is to generate a sound responsive to the detection that the sports ball has contacted the user.

8. The sports ball of claim 4, wherein a speed at which the motor assembly propels the sports ball during the tag mode is configurable by a user of the sports ball.

9. The sports ball of claim 3, wherein, during a chase mode of the sports ball, the processor is to control the motor assembly to propel the sports ball to evade the plurality of external locator tags.

10. The sports ball of claim 9, wherein the processor is to detect, using one or more internal sensors, when the sports ball has been contacted by a user associated with one of the plurality of external locator tags, and wherein the sports ball further includes a speaker to output a sound responsive to the detection that the sports ball has been contacted by the user.

11. The sports ball of claim 1, wherein the location sensor is to interface with a radio frequency identification (RFID) tag of the external locator tag to determine the location of the sports ball relative to the external locator tag.

12. The sports ball of claim 1, wherein the location sensor is to determine the location of the sports ball relative to the external locator tag using Global Positioning System (GPS).

13. The sports ball of claim 1, wherein the processor is to trigger the external locator tag to output a sound based on the determined location of the sports ball relative to the external locator tag.

14. The sports ball of claim 1, further comprising one or more internal sensors to determine when the sports ball has been moved by a user of the sports ball, wherein the processor is to control the motor assembly to stop self-propulsion of the sports ball responsive to the determination that the sports ball has been moved by the user.

15. The sports ball of claim 14, further comprising a speaker coupled to the processor, wherein the speaker is to output a sound responsive to the determination that the sports ball has been moved by the user.

16. The sports ball of claim 1, wherein, during a side-to-side mode of the sports ball, the sports ball is to roll back and forth in front of a user associated with the locator tag.

17. The sports ball of claim 1, wherein, during a race mode, the processor is to control the motor assembly to propel the sports ball toward the locator tag, wherein a speed at which the motor assembly is to propel the sports ball during the race mode is configurable by a user of the sports ball.

18. A location-aware self-propelled sports ball system, comprising:
a locator tag;
a sports ball including:
a motor assembly to propel the sports ball along the ground;
a location sensor to determine a location of the sports ball relative to an external locator tag;
a processor to control the motor assembly to propel the sports ball based on the determined location of the sports ball relative to the external location tag.

19. The sports ball system of claim 18, wherein the locator tag is a first locator tag, wherein the sports ball system includes a plurality of locator tags including the first locator tag, wherein the location sensor is to determine the location of the sports ball relative to a plurality of locator tags, and wherein the processor is to control the motor assembly to propel the sports ball based on the determined location of the sports ball relative to the plurality of locator tags.

20. The sports ball system of claim 18, wherein the locator tag includes a speaker, and wherein the processor of the sports ball is to trigger the speaker to output a sound based on the location of sports ball and a mode of operation of the sports ball.

21. The sports ball system of claim 18, wherein the locator tag is a dedicated device in the form of a wearable bracelet.
